(19) United States
(12) Patent Application Publication
(10) Pub. No.: US 2018/0334232 A1
(43) Pub. Date: Nov. 22, 2018

(54) Illuminated stern light for boats

(71) Applicants: Wayne Gerard Poole, Alexandria, VA (US); Steven Carl Anderson, Woodbridge, VA (US)

(72) Inventors: Wayne Gerard Poole, Alexandria, VA (US); Steven Carl Anderson, Woodbridge, VA (US)

(21) Appl. No.: 15/932,883

(22) Filed: May 16, 2018

Related U.S. Application Data
(60) Provisional application No. 62/603,123, filed on May 18, 2017.

(51) Int. Cl. B63B 45/04; F21V 23/06; F21V 23/00; F21V 23/04

(52) U.S. Cl. CPC B63B 45/04; F21V 23/06; F21Y 2115/10; F21V 23/0435; F21V 23/003

(57) ABSTRACT

A stern light manually insertible into and removable from a powered socket such as for a boat, is shown and described. The stern light comprises a light transmissive elongated post with a plurality of point light sources. Each point light source is individually controllable as to on-off and as to color, either from local pushbuttons or from a portable wireless transmitter. The point light sources may be controlled by a programmable controller which responds to the local pushbuttons or to the portable wireless transmitter, and may illuminate according to various lighting sequences, such as constantly on and such as flashing.

### REFERENCE TO RELATED APPLICATION

This application claims priority of application Ser. No. 62/603,123, filed May 18, 2017.

### FIELD OF THE INVENTION

The present invention relates to safety lights, and more particularly, to safety lights on poles for small watercraft.

### BACKGROUND OF THE INVENTION

Boats, such as pleasure craft, are required to display a white light at the stern of the boat. These lights, called stern lights, are currently available in manually installable and removable form. The light, mounted on a pole, is installed by plugging the pole into an electrified socket which is a permanent part of the boat. On small boats accommodating two to eight passengers, the pole is typically two to five feet high. The pole includes a terminal bearing electrically conductive sockets intended to mate with corresponding electrically conductive prongs in the electrified socket. Once manually fully inserted into the socket, the light, located at the upper end or head of the stern light, can be illuminated by energizing an electrical circuit connected to the socket. This is ordinarily accomplished by a switch mounted proximate the operator of the boat, such as on a dashboard.

Stern lights increase visibility of the boat in darkness, fog, and other conditions. However, a stern light illuminates a relatively small area, typically comprising a single light bulb or other point light source. Even a small object interposed between the point light source of a stern light can obscure the light to an observer located away from the boat. In darkness, fog, or smoke, an entire small boat can become invisible toothers using a waterway. The potential for collisions and other mishaps is considerable.

### SUMMARY OF THE INVENTION

The present disclosure therefore proposes an improved stern light which is illuminated along at least most of its length. The stern light retains the removable nature of conventional stern lights, and relies on the conventional powered socket for energizing the light source.

The novel stern light comprises a light transmissive elongated post, and a plurality of point light sources within and along the elongated post. Each one of the plurality of point light sources is individually controllable, and may be variable in color output. The stern light terminates in a conventional connector, and is manually insertible into and removable from the powered socket.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic side view of a stern light according to one or more aspects of the present disclosure;

FIG. 2 is a diagrammatic side view of a boat having a conventional stern light;

FIG. 3 is a cross sectional detail view of one implementation of a stern light such as that of FIG. 1;

FIG. 4 is a cross sectional detail view of another implementation of a stern light such as that of FIG. 1;

FIG. 5 is a partially cross sectional detail view of a connection of components of a stern light such as that of FIG. 1;

FIG. 6 is a perspective view of a component seen towards the top of FIG. 5;

FIG. 7 is a side detail view of a further implementation of a stern light such as that of FIG. 1;

FIG. 8 is an end detail view taken along line 8-8 in FIG. 1;

FIG. 9 is a cross sectional detail view of an end of another implementation of a stern light such as that of FIG. 1;

FIG. 10 is a perspective detail view of an alternative form of the components shown in FIG. 9;

FIG. 11 is an environmental cross sectional detail view of coupling of a stern light such as that of FIG. 1 to a boat;

FIG. 12 is an environmental side view of another coupling of a stern light such as that of FIG. 1 to a boat;

FIG. 13 is a side view of still another implementation of a stern light such as that of FIG. 1; and

FIG. 14 is a schematic vie of a programmable controller usable with any implementation of a stern light such as that of FIG. 1.

### DETAILED DESCRIPTION

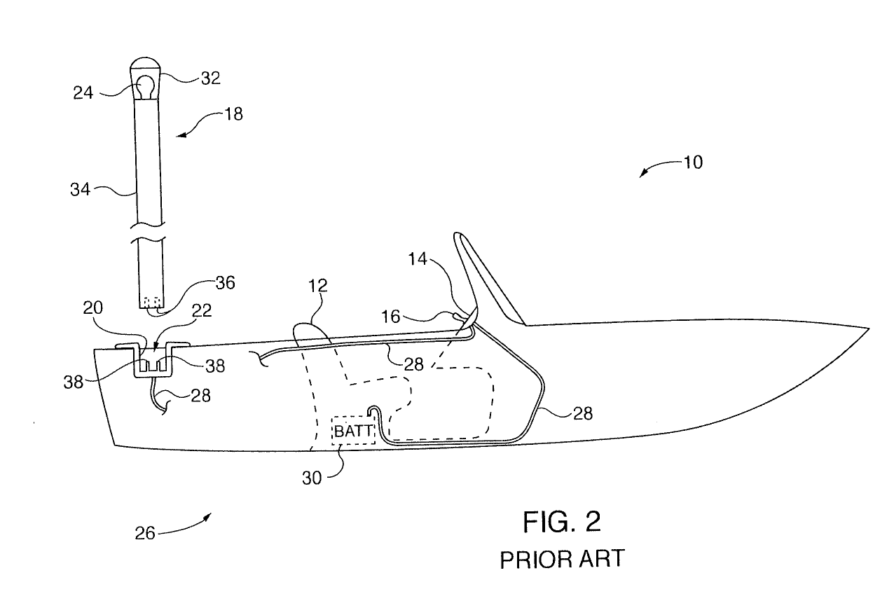

Referring initially to FIG. 2, a boat 10 is seen to have an operator's station including a seat 12 and a dashboard 14 for supporting controls within ready reach of the operator. One of the controls is a switch 16, depicted as a manually operated toggle switch, for energizing a stern light 18. Stern light 18 is received in friction fit within a socket 20 permanently installed on boat 10. Socket 20 conventionally includes electrically conductive prongs 38 for completing an electrical circuit to a light bulb 24 or other light source of stern light 18. Electrical circuitry 26 (represented as a cable 28, and not shown in its entirety) connects a battery 30 to light bulb 24 via switch 16. Light bulb 24 is contained within a translucent or transparent head 32 mounted to one end of an elongated pole 34. Elongated pole 34 is manually inserted into socket 22. Electrically conductive openings 36 receive and transmit electrical power from prongs 38. Stern light 18 is typically installed in socket 22 at dusk, and left there until the next day's sun light, or until boat 10 is taken out of service for the day. The operator illuminates light bulb 24 by switch 16. Of course, it would be possible to leave switch 16 in the “on” position, and extinguish lamp 24 by removing stern light 18 from socket 20. Stern lights are usually removed during daylight hours as they become a nuisance, obstructing access across the stern or other portion of the hull of boat 10.

As used herein, reference to an article as being mounted on or to another component does not necessarily imply direction connection between the article and the other component, as an intervening member may possibly be present. Mounting on or to another component signifies that the article is ultimately fixed to and supported by the other component.

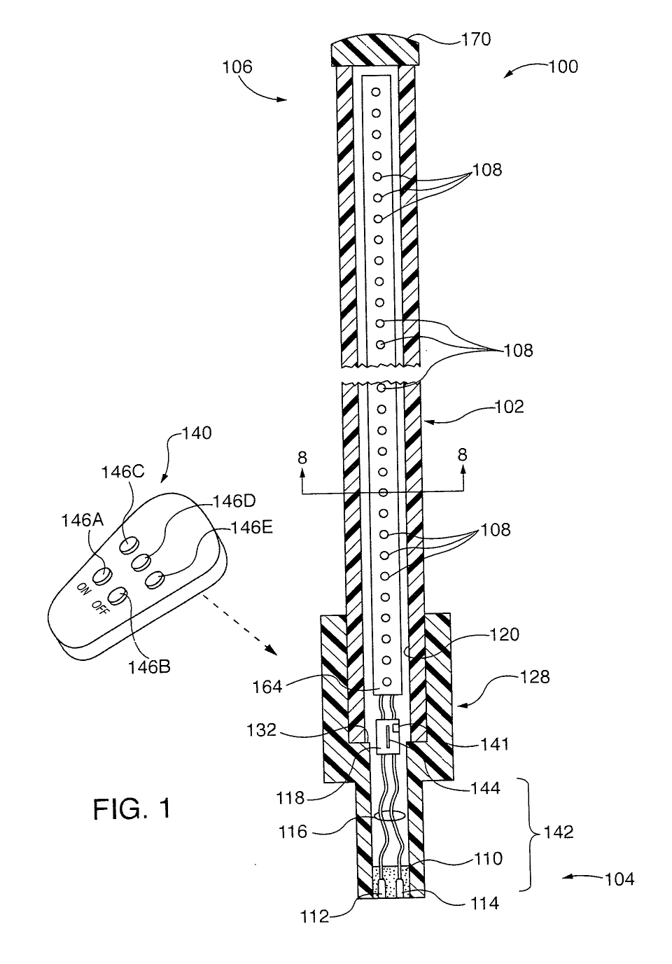

Referring to FIGS. 1 and 2, the present disclosure describes a stern light 100 illuminated along most of its length. Stern light 100 is manually insertible into and removable from powered socket 22 having internal energizable prongs 38. Stern light 100 comprises a light transmissive elongated post 102 having a proximal end 104 and a distal end 106, a plurality of point light sources 108 within and along elongated post 102, and a connector 110 at a proximal end 104 of elongated post 102, connector 110 including at least a first incuse electrically conductive opening 112 and a second incluse electrically conductive opening 114. Electrical circuitry 116 connects each of first electrically conductive opening 112 and second electrically conductive opening 114 to each one of the point light sources 108 within elongated post 102.

Unless otherwise indicated, the terms “first”, “second”, etc., are used herein merely as labels, and are not intended to impose ordinal, positional, or hierarchical requirements on the items to which these terms refer. Moreover, reference to, e.g., a “second” item does not either require or preclude the existence of, e.g., a “first” or lower-numbered item, and/or, e.g., a “third” or higher-numbered item.

As used herein, the phrase “at least” explicitly contemplates more than one of the recited article.

Elongated post 102 is fabricated from a light transmissive (i.e., translucent or transparent) substance such as polycarbonate plastic. Polycarbonate is one of a number of possible constituent materials which may be utilized to form elongated post 102. Other materials which may be substituted include other transparent or translucent plastics, such as acrylic plastics. Polycarbonate is readily commercially available, light in weight, readily extruded, and strong enough to serve as a suitable material for elongated post 102. Synthetic materials such as polycarbonate may optionally be reinforced with carbon fiber, fiberglass, and other materials. Polycarbonate may be coated or impregnated with a material resistant to ultraviolet light.

First and second incuse electrically conductive openings 112, 114 match conventional sizes and spacing of power prongs 38. Therefore, stern light 100 is a direct replacement for conventional stern light 18. That is, stern light 100 can be manually installed into socket 22, and will removably engage the latter by friction. Also, prongs 38 will enter and engage first electrically conductive opening 112 and second electrically conductive opening 114 by electrical circuitry 116, to connect electrical power to point light sources 108.

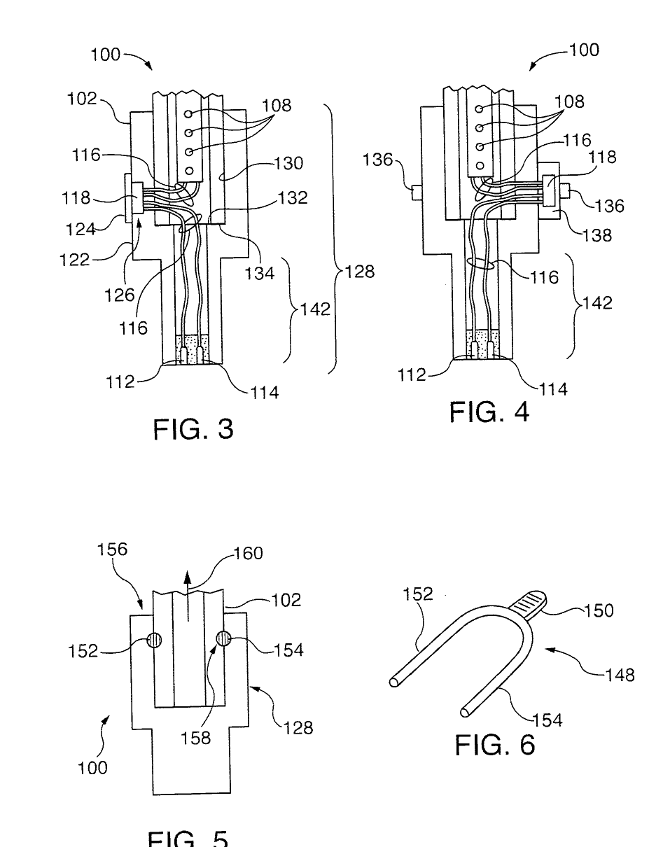

Stern light 100 may further comprise a programmable controller 118 connected to electrical circuitry 26, programmable controller 118 comprising a microprocessor 19 and a memory 121 (FIG. 14), wherein programmable controller is able to store illumination sequences to effect on-off control of each one of the plurality of point light sources 108 according to a selected illumination sequence stored in the memory. Illumination sequences are arrangements of illumination or extinguishing of each one of point light sources 108, rendered as computer instructions stored in memory 121 and operable to control power to each point light source 108. Programmable controller 118 is contained within a hollow interior or opening 120 of elongated post 102. As seen in FIG. 3, as a an alternative to location of programmable controller 118 within hollow interior or opening 120 of elongated post 102, as shown in FIG. 1, programmable controller 118 is coupled to an exterior 122 of light transmissive elongated post 102. In this latter location, programmable controller 118 is protected by a removable or permanently fixed closure 124 which covers a chamber 126 containing programmable controller 118.

Programmable controller 118 is separate from stern light 100 and may comprise a microprocessor, a memory, and computer instructions loaded into the memory in a non-transitory computer-readable medium that when executed, are configured to instruct the microprocessor to selectively control electric power to individual ones of the plurality of point light sources 108 to effect a selected illumination sequence. Alternatively, the computer instructions defining each selectable illumination sequence may be stored in a memory and processed by a microprocessor contained within stern light 100.

Programmable controller 118 may be fabricated specifically as a custom device for incorporation into stern light 100, or alternatively, may be an existing commercial product. A suitable data processing programmable controller may comprise an electrical microprocessor made for example by Arduino. The microprocessor available from Arduino is an open-source electronics platform based on easy-to-use hardware and software. Arduino is a commercial entity which intends its products for use by those creating projects having interactive features. Commercially available programming products of Arduino may be found online for example at a retailer such as Adafruit Industries (https://www.adafruit.com/products/191). Arduino product Mega 2560 R3 (Atmega 2560, product number 191, has proved satisfactory in the role of programmable controller 118.

It should be mentioned at this point that elongated post 102 may be monolithic, or alternatively, may be formed in complementary sections. The latter construction is depicted in FIGS. 1 and 3, wherein elongated post 102 is received within an adapter body 128. Called out explicitly in FIG. 3, adapter body 128 has a stepped internal bore 130. A shoulder or ledge 132 formed in adapter body 128 fixes position of elongated post 102 relative to adapter body 128 when elongated post 102 is inserted into adapter body 128, as an end surface 134 of elongated post 102 abuts shoulder or ledge 132. Providing adapter body 128 enables elongated post 102 to be furnished as a length of stock tubing, cut to any desired length, such as two to six feet, with elongated post 102 being suitably bonded to adapter body 128. Light transmissive elongated post 102 has an exposed length between two and five feet, and a concealed length. The concealed length may be that portion of elongated post 102 received within adapter body 128, or alternatively, where there is no separate adapter body 128, that portion received within socket 22.

Adapter body 128 may be made by injection molding in final or net shape. Alternatively, adapter body 128 may be made by a subtractive method wherein material is abraded from an initial workpiece (e.g, by machining), or by an additive method such as three dimensional printing.

As seen in an option illustrated in FIG. 4, programmable controller 118 is clamped to light transmissive elongated post 102, or alternatively, to adapter body 128 by a clamping strap 136. Programmable controller 118 may be contained within a protective enclosure 138.

As seen in the example of FIG. 1, programmable controller 118 is contained within light transmissive elongated post 102. This construction eliminates need for a discrete housing or enclosure for receiving programmable controller 118. This construction may be employed when programmable controller 118 is operated by e.g. radio frequency signals. Such radio frequency signals may be encoded to prevent unintended operation of stern lights 100 of other boats when a portable wireless manual controller 140 is used to control illumination of point light sources 108. In this example, programmable controller 118 is remote from light transmissive elongated post 102.

As an alternative to radio frequency signals, portable wireless manual controller 140 may emit infrared signals. Exterior locations of infrared signal receptors of programmable controller 118 is accommodated by the arrangements of FIGS. 3 and 4, wherein programmable controller 118 is located at exterior surfaces of adapter body 128. Because infrared signals are projected generally linearly, as opposed to radial propagation of radio frequency signals, unintended operation of stern lights 100 of other boats will not become a problem. Portable wireless manual controller 140 (FIG. 1) will be aimed at a specific location (that is, the infrared receptor) on stern light 100, and it is most unlikely that another receptor of another stern light 100 will be both aligned with the infrared beam and also be within operable distance of portable wireless manual controller 140 for operation of two or more stern lights in different boats to occur.

Therefore, stern light 100 may further comprise a remote controller system capable of connecting and breaking power to the plurality of point light sources 108. The remote controller system may comprise portable wireless manual controller 140, a wireless signal receiver coupled to stern light 100, and a switch 141 (FIG. 1) in electrical circuitry 116, the wireless signal receiver arranged to operate switch 141. The wireless signal receiver may comprise antenna 144, or may comprise the infrared signal receptor (not separately shown). The wireless signal receiver is connected to programmable controller 118 to select and operate any one of the illumination sequences stored in memory 121 to operate point light sources 108, and to extinguish point light sources 108. This enables ready control of illumination of stern light 100 without requiring operating personnel to be immediately adjacent stern light 100.

For radio frequency signal reception, programmable controller 118 has an antenna 144. Of course, antenna 144 may be remote from data processing components of programmable controller 118. Similarly, an infrared signal receptor may be located at a suitable location on stern light 100, remote from programmable controller 118.

Adapter body 128 serves as a mounting base having an opening (i.e., stepped internal bore 130) dimensioned and configured to slidably receive light transmissive elongated post 102 therein in close cooperation therewith, and a projection 142 dimensioned and configured to slidably penetrate powered socket 22 in close cooperation therewith, and connect electrically to energizable prongs 38 of powered socket 22.

Portable wireless manual controller 140 may have input elements such as pushbuttons 146A-146E. Pushbutton 146A illuminates point light sources 108. Pushbutton 146B extinguishes point light sources 108. Pushbuttons 146C, 146D, and 146E invoke lighting sequences wherein point light sources 108 flash intermittently or blink. Blinking rates ma vary, for example, including a first blinking sequence wherein illumination and extinguishing cycles are relatively few per minute, a second blinking sequence wherein illumination and extinguishing cycles are relatively more frequent, and a third blinking sequence wherein illumination and extinguishing cycles are still more frequent. Each of these blinking sequences is initiated by one of pushbuttons 146C, 146D, or 146E. Of course, programmable controller 118 may be programmed to provide different lighting effects, such as color changes, non-simultaneous illumination of individual point light sources 108, and other dynamic effects.

Stern light 100 may further comprise programmable controller 118 connected to electrical circuitry 116, wherein programmable controller 118 comprises a data processor and a memory, wherein programmable controller 118 is able to store illumination sequences to effect on-off control of each one of the plurality of point light sources 118 according to a selected illumination sequence stored in the memory, and wherein programmable controller 118 is coupled to the mounting base (e.g., as shown in FIGS. 3 and 4).

Alternatively, stern light 100 may further comprise programmable controller 118 connected to electrical circuitry 116, wherein programmable controller 118 comprises a data processor and a memory, and wherein programmable controller 118 is able to store illumination sequences to effect on-off control of each one of the plurality of point light sources 108 according to a selected illumination sequence stored in the memory, and wherein programmable controller 108 is contained within the mounting base.

Turning to an example of stern light 100 illustrated in FIGS. 5 and 6, stern light 100 may further comprise a manual latch 148 which selectively secures light transmissive elongated pole 102 to the mounting base (i.e., adapter body 128) and releases light transmissive elongated pole 102 from the mounting base. Manual latch 148 may comprise a U-shaped pin having a grasping tab 150. Each of legs 152 or 154 occupies a slot or groove 156 or 158 formed in complementing sections in elongated pole 102 and the mounting base, and engages the slot or groove 156 or 158 by friction. When inserted into the slots or grooves 156 or 158, manual latch 148 couples elongated pole 102 to the mounting base, thereby preventing loss of elongated pole 102 from the mounting base along a longitudinal axis of elongated pole 102 (axis indicated by arrow 160).

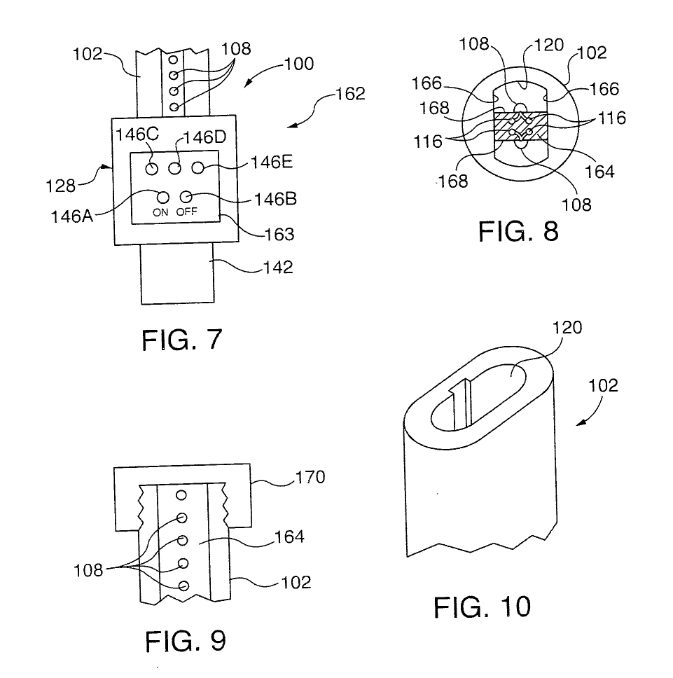

Referring to an example of stern light 100 illustrated in FIG. 7, stern light 100 may further comprise a local manual controller 162 coupled to stern light 100. Local manual controller is connected to electrical circuitry 116 to select and operate any one of the illumination sequences stored in the memory to operate point light sources 108, and extinguish point light sources 108. Local manual controller 162 may comprise a keypad 163 bearing pushbuttons 146A, 146B, 146C, 146D, and 146E, which may have functions equivalent to their similarly labeled counterparts in FIG. 1. Local manual controller 162 is integral with stern light 100, and is therefore not easily lost.

Stern light 100 may have portable wireless manual controller 140 or local manual controller 162 or both. Portable wireless manual controller 140 and local manual controller 162 are each a device providing an interface for receiving manual inputs from a person using stern light 100. Programmable controller 118, by contrast, is a data processing device which receives command signals originating from portable wireless manual controller 140 and local manual controller 162, and converts these command signals into power signals which cause point light sources 108 to illuminate, extinguish, and optionally, to change color.

Turning now to an example of stern light 100 illustrated in FIG. 8, light transmissive elongated post 102 may comprise a longitudinal internal passage, or hollow interior or opening 120. Longitudinal internal passage or hollow interior or opening 120 may have a configuration of a slot. Point light sources 108 are mounted on a substrate 164 slidably engageable with the slot in close cooperation therewith. Substrate 164 is constrained against twisting along its length when inserted into the slot. Configuration of hollow interior or opening 120 as a slot signifies that in the cross sectional view of FIG. 8, hollow interior or opening 120 is non-circular, and ma have one or more flat facets 166 against which substrate may lodge t prevent rotation of substrate 164 within hollow interior or opening 120. This assures that point light sources 108 will always face in intended directions, such as fore and aft relative to boat 10 (shown in its entirety in FIG. 2).

Substrate 164 may have two major faces 168 with at least one series of the point light sources 108 on each one of the two major faces 168. This arrangement assures that light will project in two opposed directions from stern light 100, thereby maximizing visibility of stern light 100 when two strips or series of point light sources 108 are provided. At least part of electrical circuitry 116 is carried within substrate 164. This avoids having exposed wiring throughout that portion of elongated post 102 which carries point light sources 108 visible from the exterior of stern light 100.

Referring again to FIG. 1, distal end 106 of light transmissive elongated post 102 has a permanent closure, such as cap 170. Cap 10 prevents water from entering elongated post 102 and exposing electrical components to injurious effect. Making cap 170 a permanent closure eliminates potential inadvertent loss of cap 170.

In another example of stern light 100, distal end 106 of light transmissive elongate post 102 may have a removable closure. In this example, illustrated in FIG. 9, cap 170 threads to elongated pole 102. This enables substrate 164 and point light sources 108 to be readily removed from elongated pole 102 and replaced, if required for servicing defects.

In an example of stern light 100 illustrated in FIG. 10, light transmissive elongated post 102 has an oblong outer configuration I cross sections taken along the length of light transmissive elongated post 102. Making the outer configuration oblong accommodates larger substrates 164. The oblong outer configuration is asymmetric. That is, the otherwise elliptical configuration of hollow interior or opening 120 has a keyway 172, enabling a substrate 164 to be installed only one way within elongated post 102, and to resist twisting, rotation, and other disruptive movement within elongated post 102.

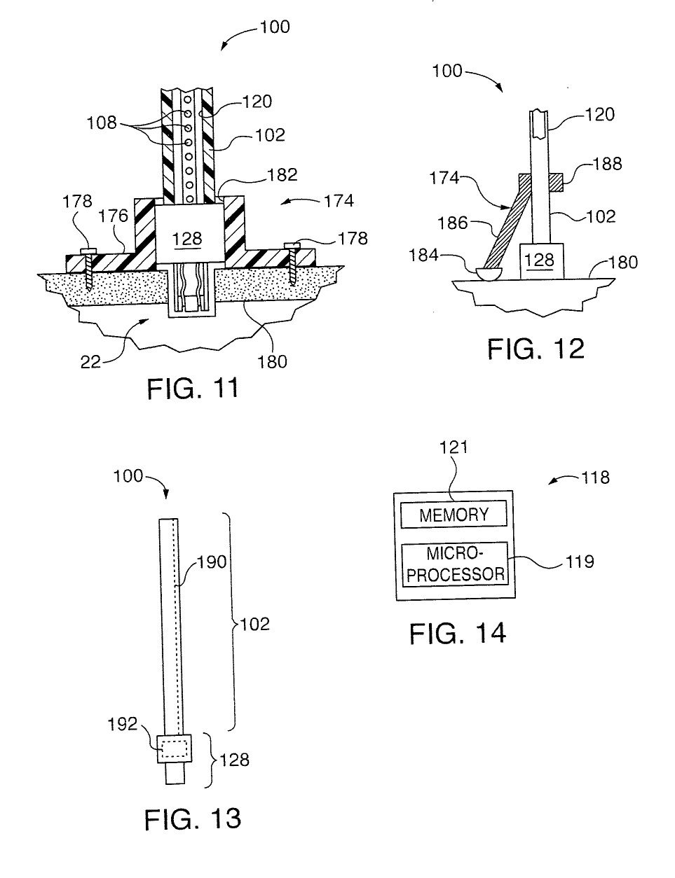

Turning now to an example of a stern light 100 shown in FIG. 11, stern light 100 may further comprise a rigidifying bracket 174 surrounding light transmissive elongated post 102. Rigidifying bracket 174 is removable from powered socket 22 and from light transmissive elongated post 102. Rigidifying bracket 174 may indirectly surround elongated post 102. That is, rigidifying bracket 174 may include a receptacle 182 contacting the mounting base, as shown in FIG. 11, which mounting base in turn surrounds elongated post 102. Rigidifying bracket 174 may have a flange 176 for receiving fasteners 178 driven into a structural substrate 180 of boat 10 (shown in its entirety in FIG. 2). Optionally, rigidifying bracket 174 is light transmissive. For example, rigidifying bracket 174 may be fabricated from polycarbonate plastic, or other translucent or transparent resinous material. If desired, rigidifying bracket 174 may be fabricated in whole or in part from a metallic material such as stainless steel. Rigidifying bracket 174 limits a whiplash effect which may occur during sailing or due to wind conditions, where whiplash could impose stresses on mounting bracket 128, socket 22, substrate 180, or any combination of these.

FIG. 12 shows a construction of stern light 100 wherein light transmissive elongated post 102 comprises longitudinal internal passage 120. Rigidifying bracket 174 may comprise a resilient foot 184 located out of registry with longitudinal internal passage 120. In the example of FIG. 12, rigidifying bracket 174 includes a leg 186 and a band 188 encircling elongated post 102. Resilient foot 184 may be for example a rubber cap installed over the end of leg 186. This construction provides a rigidifying bracket which docs not requires fasteners (e.g., fasteners 178 in FIG. 1) which must penetrate structural substrate 180 of boat 10 (FIG. 2).

Referring to an example of stern light 100 shown in FIG. 13, stern light 100 may further comprise a radio antenna 190 integrated into light transmissive elongated post 102. Radio antenna 190 connects to a radio frequency receiver 192 connected in turn to programmable controller 118 (FIG. 1). This construction affords a protected location for radio antenna 190, while increasing length and reception capability of radio antenna 190 over that of antenna 144 shown in FIG. 1. Radio antenna 190 receives control commands from portable wireless manual controller 140 (FIG. 1).

Point light sources 108 may comprise light emitting diodes (LEDs). Point light sources 108 may be provided as prefabricated strips including substrate 164 (FIG. 8). Such prefabricated strips are commercially available, for example, from a retailer such a Adafruit Industries, such as NeoPixel digital RGB LED strip, product identification 1461 (https://www.adafruit.com/products/1461).

Each LED is a three-part LED assembly including one red constituent LED, one green constituent LED, and one blue constituent LED. Electrical conductors pass through substrate 164 and are connected to each red constituent LED of each three-part LED assembly, each green constituent LED of each three-part LED assembly, and each blue constituent LED of each three part LED assembly, such that each point light source 108 is individually addressable by one of the electrical conductors contained within and integral to substrate 164. Not only are point light sources 108 individually addressable, each of the red, green, and blue constituent LEDs of any one point light source 108 are individually addressable. This enables any one point light source 108 to be controlled as to color or hue, and on-and-off independently from other point light sources 108. In turn, great versatility in creating both static and dynamic lighting patterns is easily achieved using a data processing controller (not separately shown). Also, this minimizes the number of LEDs which must be provided to attain any given level of resolution, and also minimizes the number and ampacity requirements of supporting electrical conductors of electrical circuitry 116 (e.g., as shown in FIG. 1). Hence a wide range of colors is available from a minimal number of LEDs, merely by controlling proportions of red, green and blue illumination available from each three-part LED assembly.

Electrical circuitry 116 will be understood to include both electrical conductors integrated within substrate 164 and also conductors used to join components of stern light 100 together. The later are illustrated in FIG. 1, wherein electrical circuitry 116 is seen to connect firs incuse electrically conductive opening 112 and second incuse electrically conductive opening 114 t programmable controller 118, and programmable controller 118 to electrical conductors integrated into substrate 164.

Thus, in stern light 100, electrical circuitry 116 is arranged to control each one of the plurality of point light sources 108 individually. Also, in stern light 100, each one of the plurality of point light sources 108 is capable of projecting light of different colors. In stern light 100, each one of the point light sources 108 may comprise an LED, and each LED is an assembly of at least one red LED, at least one green LED, and at least one blue LED.

It should not be inferred from the drawings that LEDs can only be arranged as a single row. A series of LEDs may include more than one row of LEDs.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A stern light manually insertible into and removable from a powered socket having internal energizable prongs, the stern light comprising:
a light transmissive elongated post having a proximal end and a distal end;
a plurality of point light sources within and along the elongated post;
a connector at the proximal end of the elongated post, the connector including at least a first incuse electrically conductive opening and a second incuse electrically conductive opening; and
electrical circuitry connecting each one of the first electrically conductive opening and the second electrically conductive opening to each one of the point light sources within the elongated post.

2. The stern light of claim 1, further comprising a programmable controller connected to the electrical circuitry, the programmable controller comprising a data processor and a memory, wherein the programmable controller is able to store illumination sequences to effect on-off control of each one of the plurality of pint light sources according to a selected illumination sequence stored in the memory.

3. The stern light of claim 2, wherein the programmable controller is coupled to an exterior of the light transmissive elongated post.

4. The stern light of claim 3, wherein the programmable controller is clamped to the light transmissive elongated post.

5. The stern light of claim 2, wherein the programmable controller is contained within the light transmissive elongated post.

6. The stern light of claim 2, wherein the programmable controller is remote from the light transmissive elongated post.

7. The stern light according to claim 1, further comprising a mounting base having an opening dimensioned and configured to slidably receive the light transmissive elongated post therein in close cooperation therewith, and a projection dimensioned and configured to slidably penetrate the powered socket in close cooperation therewith, and connect electrically to the energizable prongs of the powered socket.

8. The stern light of claim 7, further comprising a programmable controller connected t the electrical circuitry, the programmable controller comprising a data processor and a memory, wherein the programmable controller is able to store illumination sequences to effect on-off control of each one of the plurality of point light sources according to a selected illumination sequence stored in the memory, wherein the programmable controller is coupled to the mounting base.

9. The stern light of claim 7, further comprising a programmable controller connected t the electrical circuitry, the programmable controller comprising a data processor and a memory, wherein the programmable controller is able to store illumination sequences to effect on-off control of each one of the plurality of point light sources according to a selected illumination sequence stored in the memory, wherein the programmable controller is contained within the mounting base.

10. The stern light of claim 7, further comprising a manual latch which selectively secures the light transmissive elongated pole to the mounting base and releases the light transmissive elongated pole from the mounting base.

11. The stern light of claim 1, further comprising a remote controller system capable of connecting and breaking power to the plurality of point light sources, the remote controller system comprising:
a portable wireless manual controller;
a wireless signal receiver coupled to the stern light; and
a switch in the electrical circuitry, the wireless signal receiver arranged to operate the switch.

12. The stern light of claim 11, wherein the wireless signal receiver is connected to the programmable controller to select and operate any one of the illumination sequences stored in the memory to operate the point light sources, and to extinguish the point light sources.

13. The stern light according to claim 1, further comprising a local manual controller coupled to the stern light, the local manual controller connected to the electrical circuitry to select and operate any one of the illumination sequences stored in the memory to operate the point light sources, and to extinguish the point light sources.

14. The stern light of claim 1, wherein the light transmissive elongated post comprises a longitudinal internal passage.

15. The stern light of claim 14, wherein
the longitudinal internal passage has a configuration of a slot;
the point light sources are mounted on a substrate slidably engageable with the slot in close cooperation therewith; and
the substrate is constrained against twisting along its length when inserted into the slot.

16. The stern light of claim 15, wherein the substrate comprises two major faces with at least one series of the point light sources on each one of the two major faces.

17. the stern light of claim 15, wherein at least part of the electrical circuitry is carried within the substrate.

18. The stern light of claim 1, wherein the distal end of the light transmissive elongated post has a permanent closure.

19. The stern light of claim 1, wherein the distal end of the light transmissive elongated post has a removable closure.

20. The stern light of claim 1, wherein the light transmissive elongated post has an oblong outer configuration in cross sections taken along the length of the light transmissive elongated post.
